(19) United States
(12) Patent Application Publication
(10) Pub. No.: US 2026/0349976 A1
(43) Pub. Date: Nov. 5, 2026

(54) LARGE LANGUAGE MODEL (LLM)-ASSISTED QUALITY EVALUATION AND REFINEMENT OF AN ARTIFICIAL INTELLIGENCE (AI) ASSISTANT SYSTEM

(71) Applicant: Zoom Communications, Inc., San Jose, CA (US)

(72) Inventors: Guohao Chen, Suzhou (CN); Zheng Chen, Bellevue, WA (US); Jianbing Han, Los Gatos, CA (US); Tao Huang, Hangzhou (CN); Ying Lu, Cerritos, CA (US); Kai Ni, Sammamish, WA (US); Jun Tan, Pittsburgh, PA (US); Wang Tian, Hefei (CN); Yuangang Tu, Kirkland, WA (US); Xi Yun, Redmond, WA (US)

(73) Assignee: Zoom Communications, Inc., San Jose, CA (US)

(21) Appl. No.: 19/194,487

(22) Filed: Apr. 30, 2025

(51) Int. Cl. G06F 16/215; G06F 40/40

(52) U.S. Cl. CPC G06F 16/215; G06F 40/40

(57) ABSTRACT

Systems and methods of Large Language Model (LLM)-assisted quality evaluation of an Artificial Intelligent (AI) assistant system are provided. A communication platform selects one or more test datasets from communication data associated with a communication platform. The communication platform generates one or more test queries based on the one or more test datasets using a first LLM. The communication platform provides the one or more test queries to an AI assistant system associated with the communication platform to obtain one or more test responses. The communication platform evaluates a performance of the AI assistant system at least based on the one or more test responses and the one or more test datasets associated with the one or more test queries using a second LLM to generate evaluation data. The communication platform updates the AI assistant system based on the evaluation data.

### FIELD

The present application generally relates to artificial intelligence and more specifically relates to large language model (LLM)-assisted quality evaluation and refinement of an artificial intelligence (AI) assistant system.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides chat and videoconferencing functionality to various client devices.

FIG. 2 shows an example system in which a chat and video conference provider provides chat and videoconferencing functionality to various client devices.

FIG. 3 shows an example system for using generative AI models to perform certain generative tasks based on communication data generated on a communication platform.

FIG. 4 shows an example system that is configured for quality evaluation and refinement of an AI assistant system.

FIG. 5 shows an example process for evaluating and updating an AI component of an AI assistant system.

FIG. 6 shows an example computing device suitable for use in example systems or methods for LLM-assisted quality evaluation of an AI assistant system.

### DETAILED DESCRIPTION

Examples are described herein in the context of large language model (LLM)-assisted quality evaluation and refinement of an artificial intelligence (AI) assistant system. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Conventionally, human annotation or labeling is used for evaluating artificial intelligence (AI) systems. However, human labeling can introduce subjective biases, and feedback loops involving human intervention are typically slow and costly. As AI systems evolve, there is a need for faster and more objective evaluation methods, particularly for AI assistant systems that rely on large amounts of communication data on a communication platform.

To evaluate the performance of an AI system accurately and timely for continuous improvement, it is desirable for a communication platform to provide a large language model (LLM)-based evaluation system for automated evaluation of an AI assistant system. The communication platform includes the AI assistant system configured to generate responses to a user query based on communication data generated on the communication platform. The LLM-based evaluation system uses LLMs to objectively and timely evaluate the performance of the AI assistant system and provide instant feedback and actionable insights.

For example, the LLM-based evaluation system retrieves a subset of communication data from the communication platform. The subset of communication data is ground truth data, and may include multiple test datasets.

For example, a test dataset can be a meeting transcript or a chat log. The LLM-based evaluation system uses or implements an LLM to generate one or more test queries based on a test dataset. A test query is usually a question that users commonly ask the AI assistant system. The answer to the test query is included in a corresponding test dataset that is used to generate the test query.

The LLM-based evaluation system provides a test query to the AI-based assistant system. The AI-based assistant system generates a test response to the test query and provides the test response and related data (e.g., intermediate data) to the LLM-based evaluation system. The related data includes relevant data identified by a similarity model used in the AI assistant system, ranking of the identified relevant data by a re-ranking model used in the AI assistant system, and a subset of relevant data (e.g., top 5 of the relevant data) used for generating the response by a generator model of the AI assistant system.

The LLM-based evaluation system evaluates the test responses and the related data provided by the AI-based assistant system to obtain evaluation data related to the performance of the AI-based assistant system. In some examples, the LLM-based evaluation system evaluates the performance of a specific AI component of the AI assistant system. For example, the LLM-based evaluation system evaluates a similarity model of the AI assistant system used to identify relevant data for generating the response. The LLM-based evaluation system analyzes the identified relevant data based on the one or more ground-truth test dataset associated with the test queries using an LLM. The LLM-based evaluation system determines an overall relevancy accuracy score to indicate the ability of the similarity model to identify relevant data, which is used to generate query responses. In some examples, the LLM-based evaluation system also determines whether the similarity model performs better for certain types of queries over other types of queries. For example, the overall relevancy accuracy score is higher for retrieving chat messages than those for summarizing certain portion of a meeting. In another example, the LLM-based evaluation system evaluates a re-ranking model of the AI assistant system used to re-rank the identified relevant data. The LLM-assisted evaluation system provides an overall quality score based on various evaluations cores, such as recall scores, precision scores, relevancy accuracy scores, and re-ranking accuracy scores, as part of the evaluation data. All the evaluation data is provided to the AI-based assistant system as feedback for automatic updating (e.g., fine-tuning, or replacing) certain AI components.

Thus, the present disclosure leverages LLMs to evaluate responses and intermediate data to provide feedback on the performance of the AI-based assistant system. The LLM-based evaluation system eliminates human biases and increases the speed at which an AI component of the AI-based assistant system can be evaluated and improved. Moreover, it allows for evaluation of different types of AI models used by the AI-driven evaluation system for targeted improvement.

This illustrative example is given to introduce the reader to the general subject matter discussed herein and the disclosure is not limited to this example. The following sections describe various additional non-limiting examples of LLM-assisted quality evaluation and refinement of an AI assistant system.

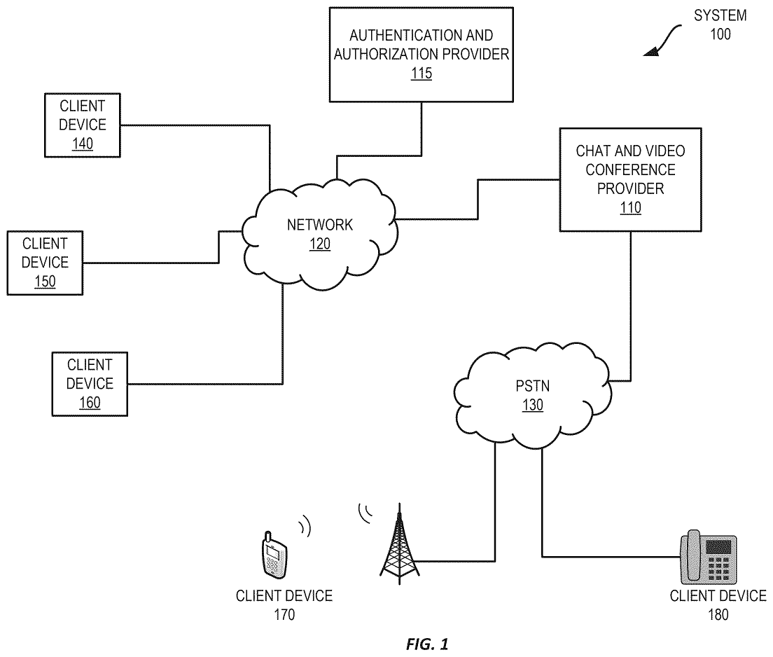

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

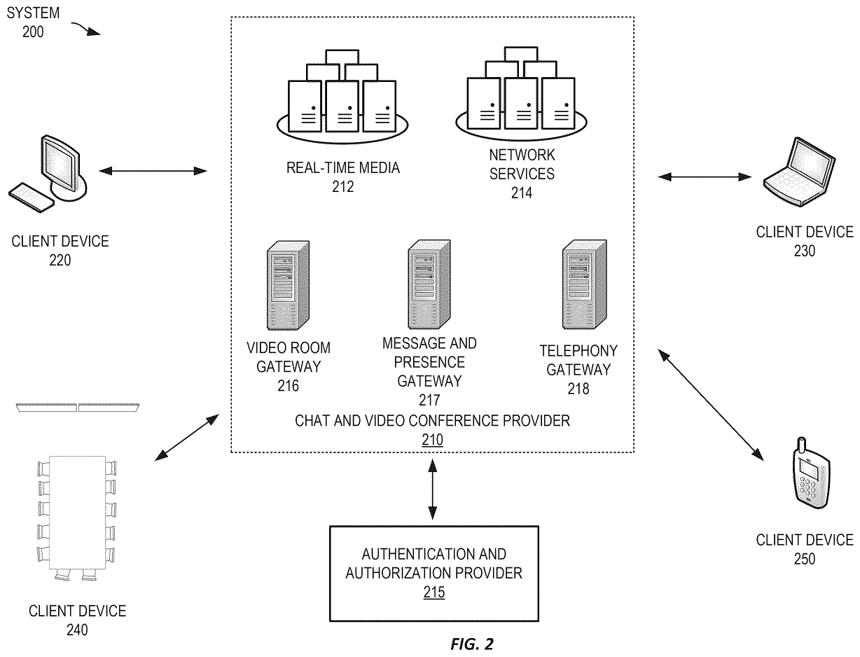

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220′s own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

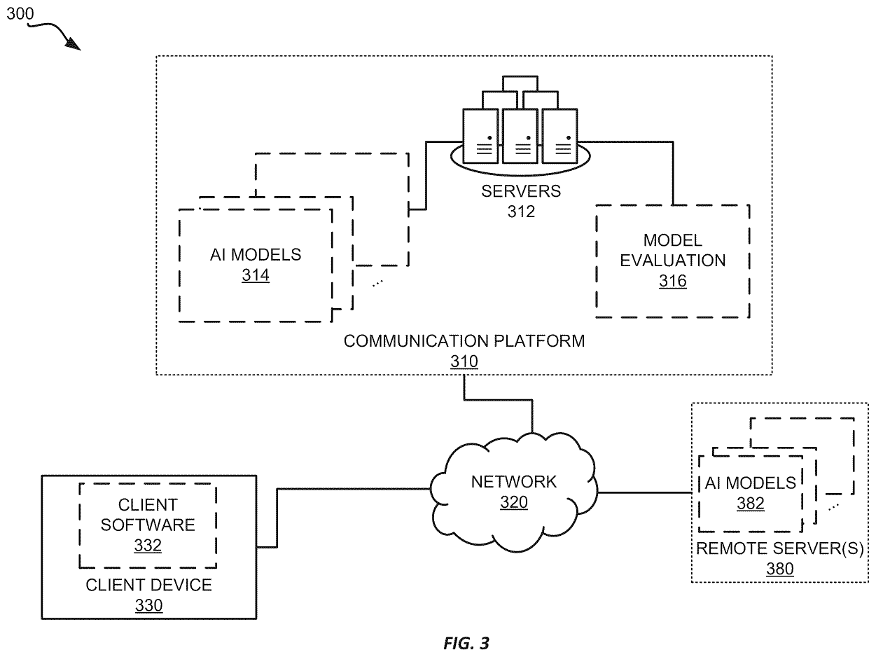

Referring now to FIG. 3, FIG. 3 shows an example system 300 for using generative AI models to perform certain generative tasks based on communication data generated on a communication platform. In this example, the system 300 includes a client device 330, a communication platform 310, and one or more remote servers 380 in network communication with network 320. In this example, the communication platform 310 provides chat and virtual conferencing capabilities, such as discussed above with respect to FIGS. 1-2, but also provides one or more servers 312 that use one or more AI models 314 (e.g., LLMs) to service requests received from users via their respective client device, such as client device 330. The AI models 314 includes a model that has been trained or fine-tuned on a large corpus of data, such as information available from licensed, commercially usable, non-public datasets. For LLMs, the training data may be written materials, such as webpages, documents, emails, or blogs that may be relevant to generating written works. In some examples, AI models 314 includes a retrieval model configured to retrieve data relevant to a user query from a data store associated with an enterprise and a generator model configured to generate a response to the user query based on the retrieved relevant knowledge data. In addition, the communication platform 310 provides evaluation functionality 316 to evaluate capabilities of the AI models and provide corresponding feedback for fine-tuning. The one or more remote servers 380 host one or more AI models 382 (e.g., LLMs), which can be used by the servers 312 on the communication platform 310, in addition to or as alternatives to the AI models 314, to service requests received from users.

Client devices 330 may execute client software 332 to join and participate in virtual conferences hosted by the communication platform 310. During a virtual conference, the participants can exchange audio and video streams, as discussed above with respect to FIGS. 1-2, to interact with each other, discuss any topics of interest, and share content. Similarly, the participants can continue any discussions outside of a virtual conference, such as by using chat functionality provided by the communication platform 310. They may also email each other using email services provided by the communication platform 310 or another third party.

A user may enter a user query, via a client device 330, for searching certain data on the communication platform 310. The user query can be provided to a trained generative AI model, such as an LLM, which is from the AI models 314 or 382. The trained general AI model can generate a response to the user query. The model evaluation functionality 316 can evaluate the performance of the AI models 314 or 382, as described in detail below.

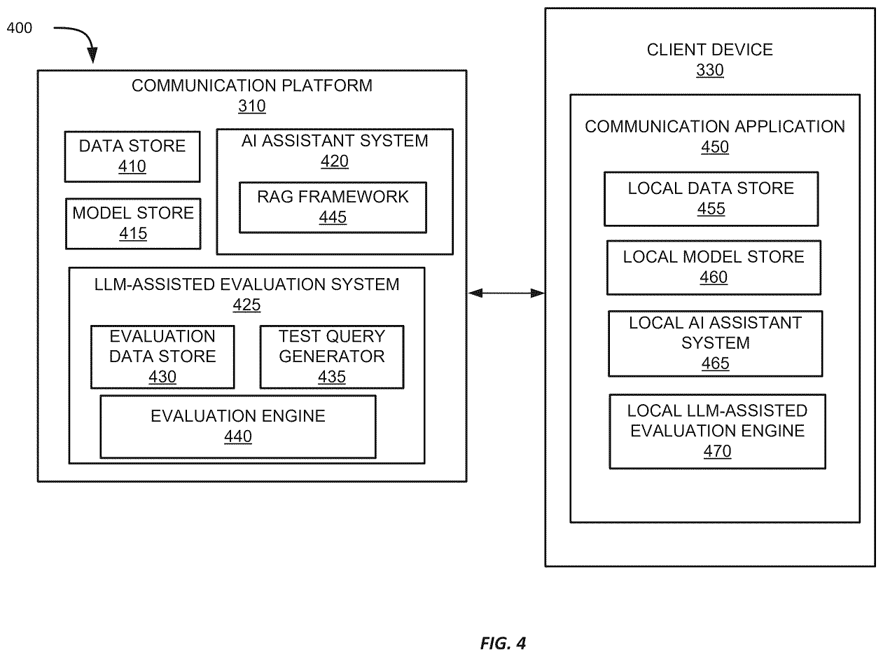

Referring now to FIG. 4, FIG. 4 shows an example system that is configured for quality evaluation and refinement of an AI assistant system. The communication platform 310 is in network communication with a client device 330. The communication platform 310 includes a data store 410, a model store 415, an AI assistant system 420, and an LLM-assisted evaluation system 425. The LLM-assisted evaluation system 425 includes an evaluation data store 430, a test query generator 435, and an evaluation engine 440. The data store 410 stores communication data associated with different client devices 330 connected to the communication platform 310, user data, and enterprise data, among other types of data. The communication data include video conference recordings, video conference transcripts, chat messages, emails, and other suitable types of communication data. The user data includes user profiles and activity data. The enterprise data includes organizational charts, reports, webpages, and other data associated with the enterprise. In some examples, the data store 410 also stores user queries and corresponding responses provided by the AI assistant system 420. The data store 410 also stores intermediate datasets that were used by the AI assistant system 420 for generating a response to a user query. Examples of intermediate datasets include embeddings of a user query, search results (e.g., communication data identified to be relevant for response generation), and rankings of the search results.

The model store 415 stores AI/ML models that can be used by the AI assistant system 420 and the LLM-assisted evaluation system 425. Various types of AI/ML models may be used in example systems. For example, simple ML models, such as Linear Regression and Gradient Boosting may be used. In other examples, more sophisticated models, such as Factorization Machines (“FM”). As more data is available in a system according to these examples, deep learning models may be utilized, such as DeepFM and Wide&Deep or other similar models. Other alternative ML models that might be used include a deep convolutional neural network (“CNN”), a residual neural network (“Resnet”), or a recurrent neural network, e.g., long short-term memory (“LSTM”) models or gated recurrent units (“GRUs”) models. The ML model can also be any other suitable ML model, such as a three-dimensional CNN (“3DCNN”), a dynamic time warping (“DTW”) technique, a hidden Markov model (“HMM”), etc., or combinations of one or more of such techniques—e.g., CNN-HMM or MCNN (Multi-Scale Convolutional Neural Network). Further, some examples may employ adversarial networks, such as generative adversarial networks (“GANs”), or may employ autoencoders (“AEs”) in conjunction with ML models, such as AEGANs or variational AEGANS (“VAEGANs”). Some ML models may use transformer networks or self-attention based neural networks. Some AI/ML models are generative AI models, such as generative pre-trained transformer (GPT), Text-to-Text Transfer Transformer (T5), Bidirectional and Auto-Regressive Transformer (BART), Bidirectional Encoder Representations from Transformer (BERT), their variations, or other large language models (LLMs) or foundation models (FM). The AI/ML models in the model store 415 can be supervised or unsupervised learning models. LLMs can include regular LLMs, which can have hundreds of billions or even trillions of parameters. The LLMs can also include smaller versions of LLMs, which can have a few million to a few billion parameters. Examples of LLMs include GPT models of different types, autoregressive LLMs (e.g., Large Language Model Meta A (LLaMA)), transformer-based autoregressive LLMs (e.g., BigScience Large Open-science Open-access Multilingual Language Models (BLOOMs)), Zephyr, MISTRAL, causal decoder-only models (e.g., Falcon), MosaicML Pretrained Transformer (MPT) models, Bidirectional Encoder Representations from Transformers (BERT) models, or T5 models. Especially, some examples of small LLMs can include DistiBERT, BERT Mini, BERT Small, BERT Medium, BERT Tiny, MobileBERT, T5-small, Orca 2, GPT-Neo, GPT-J, all of which are scaled-down versions of regular LLMs. In some examples, the model store 415 stores the AI/ML models on the communication platform 310. In some examples, the model store 415 includes APIs for accessing various AI/ML models from different parts of the communication platform 310 or from remote servers 380.

The AI assistant system 420 is configured to generate a response to a user query, for example based on the communication data in the data store 410. The AI assistant system 420 uses or implements a RAG framework 445 to retrieve relevant data associated with a query and generates a response to the query based on the retrieved relevant data from the data store 410. For example, the AI assistant system 420 includes a retrieval model and a generator model within the RAG framework 445. The retrieval model uses an AI-based similarity model or certain information retrieval techniques (e.g., embedding matching) to identify data relevant to the user query from the data store 410. The AI-based similarity model measures similarities between embeddings of a query and embeddings of a dataset in the data store 410 to determine a similarity score for the corresponding dataset. The retrieval model selects one or more datasets from the data store 410 whose similarity scores are higher than a predetermined threshold. The selected datasets are considered as relevant data. In some examples, the retrieval model also includes an AI-based re-ranking model configured to re-rank the identified relevant data. The retrieval model then provides the most relevant data, e.g., the relevant data ranked top 3 or top 5 (or other predetermined quantity) among the obtained relevant data, for response generation. The generator model of the AI assistant system 420 uses or implements a generative AI model to generate a response to the query based on the most relevant data.

The LLM-assisted evaluation system 425 also selects a subset of communication data from the data store 410 on the communication platform 310. The subset of communication data is considered as ground truth data for evaluation, which can be divided into multiple test datasets. The multiple test datasets include different types of communication data. For example, a test dataset can be a meeting transcript, a chat log, an email, contract documents, or specific-area documents. In some examples, the LLM-assisted evaluation system 425 generates synthetic data to form the ground-truth test datasets. The ground-truth test datasets are stored in an evaluation data store 430 of the LLM-assisted evaluation system 425.

The LLM-assisted evaluation system 425 also includes a test query generator 435. The test query generator 435 uses or implements an LLM to generate one or more test queries based on a test dataset. The LLM is selected from the model store 415. A test query is usually a question that users commonly ask the AI assistant system 420, such as “please find the last chat message John Smith sent to me.”. The answer to the test query is included in a corresponding test dataset that is used to generate the test query, e.g., “I'll see you at 5pm tomorrow.” In some examples, the test query generator 435 or the LLM-assisted evaluation system 425 includes a query filtering system to evaluate and filter the generated test queries. For example, the query filtering system compares the generated test queries with a set of real user queries collected from the AI assistant system 420. The set of real user queries covers different types of queries, for example queries for a specific chat message, queries for a summary of a section of a meeting or an entire meeting, or queries for a meeting time available for multiple users. If a generated test query is not similar to any real user query in real user query set, the generated test query may be removed or excluded from a test query set, which is to be used for evaluating the AI assistant system 420. In some examples, the LLM-assisted evaluation system 425 maps the test queries to the corresponding ground-truth test datasets to form test data pairs. Each test data pair includes a test query and corresponding test dataset which includes an answer to the test query. The test data pairs are stored in the evaluation data store 430.

The LLM-assisted evaluation system 425 provides a test query to the AI assistant system 420. The AI assistant system 420 generates a test response to the test query and provides the test response and related data (e.g., intermediate data) to the LLM-assisted evaluation system 425. The related data includes identified relevant data, ranking of the identified relevant data, and a subset of the relevant data (e.g., top 5 of the retrieved relevant data) used for generating the response. This way, the AI assistant system 420 generates multiple test responses to multiple test queries. These test responses and corresponding related data associated with the test queries are stored in the evaluation data store 430.

The LLM-assisted evaluation system 425 includes an evaluation engine 440 configured to evaluate the test responses and the related data provided by the AI assistant system 420 to obtain evaluation data related to the performance of the AI assistant system 420. In some examples, the evaluation engine 440 determines a recall score and a precision score for the retrieval model. The recall score is the percentage of correctly identified relevant data in the total identified relevant data. The precision score measures the retrieval model's ability to accurately identify relevant data. For example, the precision score is the percentage of correctly identified relevant data in the ground truth test datasets.

In some examples, the evaluation engine 440 evaluates the performance of a specific AI component of the AI assistant system 420. For example, the evaluation engine 440 evaluates an AI-based similarity model of the AI assistant system 420, which identifies and retrieves relevant data that can be used for response generation. The evaluation engine 440 analyzes the identified relevant data and the one or more ground-truth test datasets associated with the test query, using an LLM. The evaluation engine 440 determines a relevance accuracy score based on the analysis. The relevance accuracy score indicates whether the ground-truth test datasets associated with a test query is in the identified relevant data. The relevance accuracy score can be a binary value 0 or 1. Alternatively, the relevance accuracy score is a percentage value. For example, if there are two test datasets associated with a test query, and only one test dataset shows up in the identified relevant data, the relevance accuracy score is 50%. In some examples, the evaluation engine 440 determines an aggregate relevance accuracy score, which can be a percentage value, to show the overall level that the one or more ground-truth test datasets associated with one or test queries show up in the identified relevant data.

In some examples, the evaluation engine 440 evaluates the performance of a re-ranking model of the AI assistant system 420, which re-rank relevant data identified by the AI similarity model. For example, the evaluation engine 440 analyzes the relevant data ranked as top 3 by the re-ranking model to the test query, based on the one or more ground-truth test datasets associated with the test query. In some examples, the evaluation engine 440 generates a ranking accuracy score, for example a number between 0 and 1. If all the ground-truth test datasets that are associated with a test query are ranked at the top of the ranking, the ranking accuracy score is 1. If none of the test datasets that are associated with the test query is in the top 3 of the ranking, the ranking accuracy is 0. If part of the test datasets that are associated with the test query are in the top 3 relevant data selected for response generation, the ranking accuracy score is somewhere between 0 and 1. The ranking accuracy score measures the percentage of data in the top 3 relevant data that are actually the ground-truth test datasets associated with the test query. In some examples, the evaluation engine 440 determines an aggregate ranking accuracy level, which is a percentage value, to show the overall level that the one or more ground-truth test datasets show up in the top 3 relevant data associated with the one or more test queries.

In some examples, the evaluation engine 440 evaluates the generated response with respect to its conciseness, completeness, or coherence to generate a response evaluation score. The relevance accuracy scores, the ranking accuracy scores, the recall scores, the precision score, and the response evaluation score are part of the evaluation data. In some examples, the evaluation engine 440 generates an overall quality score based on the relevance accuracy scores, the ranking accuracy scores, the recall scores, the precision scores, and the response evaluation scores to measure the overall quality of the response generated by the AI assistant system 420.

The evaluation engine 440 can also generate actionable feedback to the AI assistant system 420. For example, the LLM-assisted evaluation system 425 determines whether the similarity model or the re-ranking model performs better for certain types of queries over other types of queries. For example, the relevance accuracy score and the precision score are generally higher for retrieving chat messages than those for summarizing certain portion of a meeting. In some examples, the LLM-assisted evaluation system 425 evaluates results generated by different similarity models to select the better similarity model for the AI assistant system 420. Similarly, the LLM-assisted evaluation system 425 evaluates results generated by different re-ranking models to select the better re-ranking model for the AI assistant system 420. The AI assistant system 420 uses the evaluation data to update certain AI components of the AI assistant system 420, for example replacing or fine-tuning the similarity model, the reranking model, or the generator model.

The client device 330 is installed with a communication application 450 provided by the communication platform 310. In some examples, the communication application 450 installed on the client device 330 include a local data store 455, a local model store 460, a local AI assistant system 465, a local LLM-assisted evaluation system 470. The local data store 455 stores communication data generated at or accessible by the client device 330, user queries by the local user and corresponding responses generated by the local AI assistant system 465, local intermediate data related to response generation, and other suitable data, similar to the data store 410 on the communication platform 310. The local model store 460 stores AI/ML models or provide API to access AI/ML models on the communication platform 310 or other remote servers 380, similar to the model store 415 on the communication platform 310. The local AI assistant system 465 is configured to generate responses to user queries, similar to the AI assistant system 420 on the communication platform 310. The local LLM-assisted evaluation system 470 is configured to evaluate the performance of the local AI assistant system 465, similar to the LLM-assisted evaluation system 425 on the communication platform 310.

The communication application 450 also includes a graphical user interface (GUI) for receiving user queries and displaying responses to user queries. In some examples, the GUI includes a search box for a user to enter a user query. In some examples, the GUI includes a chat box for a user to interact with a chat bot representing the AI assistant system 420 or the local AI assistant system 465. The user can provide user feedback on the response, for example by pressing or clicking a thumbs up or thumbs down button in the GUI.

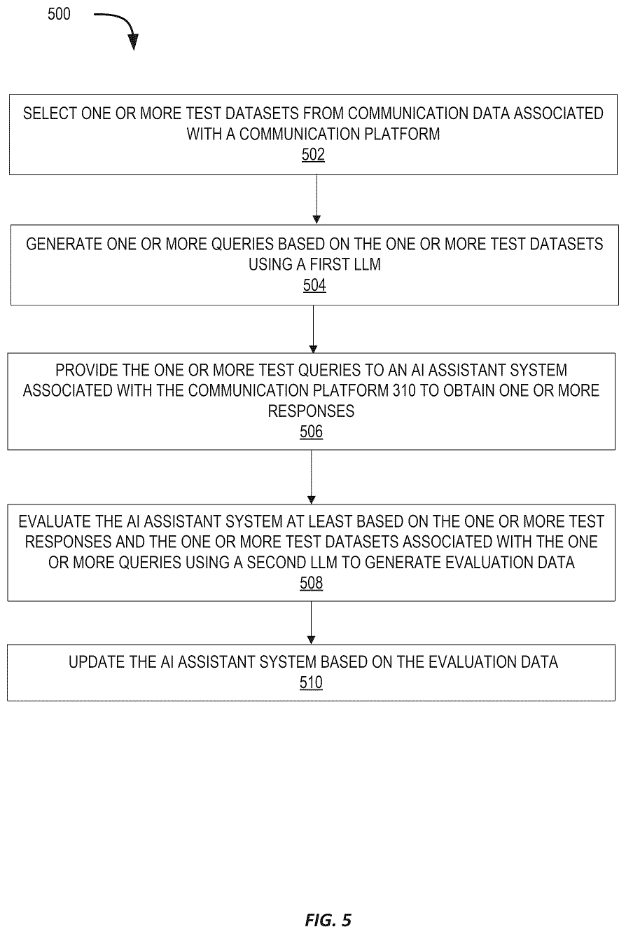

Referring now to FIG. 5, FIG. 5 shows an example process 500 for evaluating and updating an AI component of an AI assistant system. The example process 500 will be discussed with respect to the system 400 shown in FIG. 4; however, any suitable system for LLM-assisted quality evaluation of an AI assistant system may be used.

At block 502, a communication platform 310 selects one or more test datasets from communication data associated with the communication platform, generally as described in FIG. 4. For example, the LLM-assisted evaluation system 425 on the communication platform 310 retrieves the one or more test datasets by communication type. Example communication types include video conferencing, online chatting, emailing. Corresponding communication data include meeting transcripts, chat logs, and emails. The one or more test datasets include meeting transcript data, chat log data, and email data.

At block 504, the communication platform 310 generates one or more queries based on the one or more test datasets using a first LLM, generally as described in FIG. 4. For example, the test query generator 435 of the LLM-assisted evaluation system 425 uses an LLM to generate one or more test queries based on the one or more test queries respectively. In some examples, the test query generator 435 or the LLM-assisted evaluation system 425 includes a query filtering system to evaluate and filter the generated test queries based on a set of real user queries collected from AI assistant system 420. The set of real user queries covers different types of queries, such as to search for a specific chat message, to summarize a section of or an entire meeting, or to propose a meeting time for multiple users. If a generated test query is not similar to any real user query in real user query set, the generated test query may be removed or excluded from a test query set, which is to be used for evaluating the AI assistant system 420.

At block 506, the communication platform 310 provides the one or more test queries to an AI assistant system 420 associated with the communication platform 310 to obtain one or more responses, generally as described in FIG. 4. For example, the LLM-assisted evaluation system 425 provides a test query to the AI assistant system 420. The AI assistant system 420 includes a retrieval model and a generator model in a RAG framework 445. The retrieval model includes a similarity model for identifying relevant data for a query and a re-ranking model for re-ranking the relevant data. The generator model generates a test response to a corresponding test query using the top 3 or top 5 (or other quantity) of the relevant data. The AI assistant system 420 provides the test response and related intermediate data to the LLM-assisted evaluation system 425. The intermediate data associated with the test response includes identified relevant data and a ranking of the identified relevant data.

At block 508, the communication platform 310 evaluates the AI assistant system 420 at least based on the one or more test responses and the one or more test datasets associated with the one or more queries using a second LLM to generate evaluation data, generally as described in FIG. 4. For example, an evaluation engine 440 of the LLM-assisted evaluation system 425 uses a second LLM to evaluate the test responses to the test queries. In some examples, the evaluation engine 440 evaluates the performance of certain AI component of the AI assistant system 420. For example, the similarity model of the AI assistant system 420 identifies relevant data based on matching embeddings of the communication data and embeddings of a test response. The evaluation engine 440 analyzes the identified relevant data based on the one or more test datasets associated with the test query, which are the ground truth data, using an LLM. The evaluation engine 440 determines a relevance accuracy score based on the analysis. The relevance accuracy score indicates whether the ground-truth test datasets associated with a test query is in the identified relevant data. In some examples, the evaluation engine 440 determines an aggregate relevance accuracy score, which can be a percentage value, to show the overall level that the one or more test datasets associated with one or test queries show up in the identified relevant data. The aggregate relevancy accuracy score indicates the ability of the similarity model for correctly identifying relevant data.

At block 510, the communication platform 310 updates the AI assistant system 420 based on the evaluation data, generally as described in FIG. 4. For example, the AI assistant system 420 uses a first AI similarity model to identify a first set of relevant data for generating a first set of responses to a first set of test queries, and uses a second AI similarity model to identify a second set of relevant data for generating a second set of responses to the first set of test queries, generally as described at block 506. The evaluation engine 440 evaluates the first set of relevant data and the second set of relevant data based on ground-truth test datasets associated with the first set of test queries to determine which AI similarity model has a higher relevance accuracy score. If the first AI similarity model is currently used in the AI assistant system 420 but the second AI similarity model has a higher relevance accuracy score, the AI assistant system 420 updates itself by replacing the first AI similarity model with the second AI similarity model for identifying and retrieving relevant data. In some examples, the communication platform fine-tunes one or more components of the AI assistant system 420 based on the evaluation data.

The example process 500 illustrates a method for LLM-assisted quality evaluation of an AI assistant system. However, not every step in the example process 500 may be needed, some other steps may be added, or the order of the steps may be changed. Alternatively, the example process 500 can be performed by a communication application 450 installed on a client device 330.

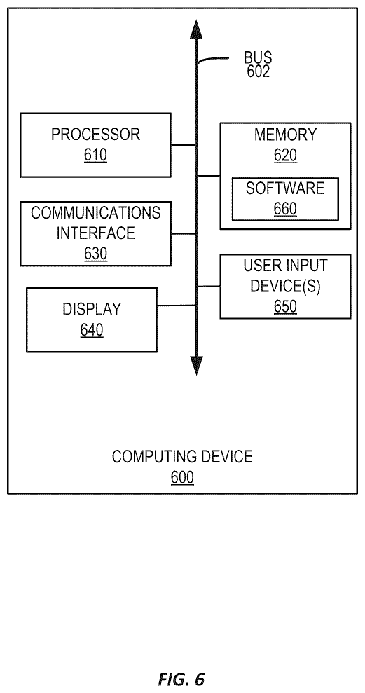

Referring now to FIG. 6, FIG. 6 shows an example computing device 600 suitable for use in example systems or methods for LLM-assisted quality evaluation and refinement of an AI assistant system. The example computing device 600 includes a processor 610 which is in communication with the memory 620 and other components of the computing device 600 using one or more communications buses 602. The processor 610 is configured to execute processor-executable instructions stored in the memory 620 to perform one or more methods for LLM-assisted quality evaluation and refinement of an AI assistant system according to different examples, such as part or all of the example process 500 described above with respect to FIG. 5. In some embodiments, the computing device may include software 660 for executing one or more methods described herein, such as for example, one or more steps of process 500. The computing device 600, in this example, also includes one or more user input devices 650, such as a keyboard, mouse, touchscreen, microphone, etc., to accept user input. The computing device 600 also includes a display 640 to provide visual output to a user.

The computing device 600 also includes a communications interface 630. In some examples, the communications interface 630 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

1. A method, comprising:
selecting one or more test datasets from communication data associated with a communication platform, the one or more test datasets comprising a subset of communication data corresponding to one or more communication types;
generating one or more test queries based on the one or more test datasets using a first large language model (LLM);
providing the one or more test queries to an artificial intelligence (AI) assistant system associated with the communication platform to obtain one or more test responses;
evaluating a performance of AI assistant system at least based on the one or more test responses and the one or more test datasets associated with the one or more test queries using a second LLM to generate evaluation data; and
updating the AI assistant system based on the evaluation data.

2. The method of claim 1, further comprising:
determining that a similarity score between a test query of the one or more test queries to a set of real user queries is below a similarity threshold; and
excluding the test query from being used for evaluation.

3. The method of claim 1, further comprising mapping the one or more test queries to the one or more test datasets to obtain one or more test data pairs, wherein each test data pair comprises a test query and corresponding test dataset which includes an answer to the test query.

4. The method of claim 1, wherein the AI assistant system comprises a similarity model configured to identify relevant data for the one or more test queries, wherein the method further comprises:
accessing identified relevant data corresponding to a test query of the one or more test queries; and
determining a relevance accuracy score for the similarity model by analyzing the identified relevant data and a test dataset corresponding to the test query.

5. The method of claim 1, wherein the AI assistant system comprises a re-ranking model configured to re-rank relevant data, wherein the method further comprises:
accessing re-ranked relevant data provided by the re-ranking model corresponding to a test query of the one or more test queries; and
determining a ranking accuracy score for the re-ranking model by comparing the re-ranked relevant data to a test dataset corresponding to the test query.

6. The method of claim 1, further comprising:
generating a first set of responses to a first set of test queries using a first AI model;
generating a second set of responses to the first set of test queries using a second AI model;
evaluating the first set of responses and the second set of responses to obtain the evaluation data; and
selecting an AI model from the first AI model and the second AI model for the AI assistant system based on the evaluation data.

7. The method of claim 1, wherein updating the AI assistant system comprises fine-tuning an AI model of the AI assistant system based on the evaluation data.

8. A system, comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
select one or more test datasets from communication data associated with a communication platform, the one or more test datasets comprising a subset of communication data corresponding to one or more communication types;
generate one or more test queries based on the one or more test datasets using a first large language model (LLM);
provide the one or more test queries to an artificial intelligence (AI) assistant system associated with the communication platform to obtain one or more test responses;
evaluate a performance of AI assistant system at least based on the one or more test responses and the one or more test datasets associated with the one or more test queries using a second LLM to generate evaluation data; and
update the AI assistant system based on the evaluation data.

9. The system of claim 8, wherein the one or more processors are configured to execute further processor-executable instructions stored in the non-transitory computer-readable medium to:
determine that a similarity score between a test query of the one or more test queries to a set of real user queries is below a similarity threshold; and
exclude the test query from being used for evaluation.

10. The system of claim 8, wherein the one or more processors are configured to execute further processor-executable instructions stored in the non-transitory computer-readable medium to:
map the one or more test queries to the one or more test datasets to obtain one or more test data pairs, wherein each test data pair comprises a test query and corresponding test dataset which includes an answer to the test query.

11. The system of claim 8, wherein the AI assistant system comprises a similarity model configured to identify relevant data for the one or more test queries, wherein the one or more processors are configured to execute further processor-executable instructions stored in the non-transitory computer-readable medium to:
access identified relevant data corresponding to a test query of the one or more test queries; and
determine a relevance accuracy score for the similarity model by analyzing the identified relevant data and a test dataset corresponding to the test query.

12. The system of claim 8, wherein the AI assistant system comprises a re-ranking model configured to re-rank relevant data, wherein the one or more processors are configured to execute further processor-executable instructions stored in the non-transitory computer-readable medium to:
access re-ranked relevant data corresponding to a test query of the one or more test queries; and
determine a ranking accuracy score for the re-ranking model by comparing the re-ranked relevant data to a test dataset corresponding to the test query.

13. The system of claim 8, wherein the one or more processors are configured to execute further processor-executable instructions stored in the non-transitory computer-readable medium to:
generate a first set of responses to a first set of test queries using a first AI model;
generate a second set of responses to the first set of test queries using a second AI model;
evaluate the first set of responses and the second set of responses to obtain the evaluation data; and
select an AI model from the first AI model and the second AI model for the AI assistant system based on the evaluation data.

14. The system of claim 8, wherein updating the AI assistant system comprises fine-tuning an AI model of the AI assistant system based on the evaluation data.

15. A non-transitory computer-readable medium comprising processor-executable instructions configured to cause one or more processors to:
select one or more test datasets from communication data associated with a communication platform, the one or more test datasets comprising a subset of communication data corresponding to one or more communication types;
generate one or more test queries based on the one or more test datasets using a first large language model (LLM);
provide the one or more test queries to an artificial intelligence (AI) assistant system associated with the communication platform to obtain one or more test responses;
evaluate a performance of AI assistant system at least based on the one or more test responses and the one or more test datasets associated with the one or more test queries using a second LLM to generate evaluation data; and
update the AI assistant system based on the evaluation data.

16. The non-transitory computer-readable medium of claim 15, further comprising processor-executable instructions configured to cause one or more processors to:
determine that a similarity score between a test query of the one or more test queries to a set of real user queries is below a similarity threshold; and
exclude the test query from being used for evaluation.

17. The non-transitory computer-readable medium of claim 15, further comprising processor-executable instructions configured to cause one or more processors to:
map the one or more test queries to the one or more test datasets to obtain one or more test data pairs, wherein each test data pair comprises a test query and corresponding test dataset which includes an answer to the test query.

18. The non-transitory computer-readable medium of claim 15, further comprising processor-executable instructions configured to cause one or more processors to:
access relevant data identified by a similarity model of the AI assistant system corresponding to a test query of the one or more test queries; and
determine a relevance accuracy score for the similarity model by analyzing the relevant data identified by the similarity model and a test dataset corresponding to the test query.

19. The non-transitory computer-readable medium of claim 15, further comprising processor-executable instructions configured to cause one or more processors to:
access a ranking of relevant data provided by a re-ranking model of the AI assistant system corresponding to a test query of the one or more test queries; and
determine a ranking accuracy score for the re-ranking model by comparing the ranking of relevant data to a test dataset corresponding to the test query.

20. The non-transitory computer-readable medium of claim 15, further comprising processor-executable instructions configured to cause one or more processors to:
generate a first set of responses to a first set of test queries using a first AI model;
generate a second set of responses to the first set of test queries using a second AI model;
evaluate the first set of responses and the second set of responses to obtain the evaluation data; and
select an AI model from the first AI model and the second AI model for the AI assistant system based on the evaluation data.
